(19) United States
(12) Patent Application Publication
(10) Pub. No.: US 2025/0371626 A1
(43) Pub. Date: Dec. 4, 2025

(54) DATA PROCESSING TOOL FOR SOCIAL MEDIA FOLLOWER SCRUBBING

(71) Applicant: Apracita Inventions Company Inc., North Las Vegas, NV (US)

(72) Inventor: Steffan Martell, Coral Gables, FL (US)

(21) Appl. No.: 18/731,245

(22) Filed: Jun. 1, 2024

(51) Int. Cl. G06Q 50/00; G06F 3/0486; G06F 16/951; G06F 40/183

(52) U.S. Cl. CPC G06Q 50/01; G06F 16/951; G06F 40/18

(57) ABSTRACT

A computer-implemented data processing method of validating legitimacy of a plurality of social media followers of a selected social media account owner, comprising steps, carried out by a social media follower scrubber tool, of: receiving an uploaded spreadsheet from a user, the spreadsheet including results of a web scraping operation, where a web scraping tool has been used to scrape data regarding the plurality of social media followers of the social media account owner selected by the user, where the spreadsheet has a plurality of rows, with each row representing one of the plurality of followers and a plurality of columns, with each column representing a characteristic feature related to the plurality of followers; and presenting the user with a drag and drop graphical user interface functionality allowing the user to rearrange and rename the columns of the uploaded spreadsheet in accordance with a native spreadsheet format.

### TECHNICAL FIELD

This disclosure relates to the technical field of data processing, and more specifically, to a data processing tool for social media follower scrubbing.

### BACKGROUND

It is very common on social media sites, such as Facebook, LinkedIn, Twitter or Instagram, that a person with a social media profile has many “followers”, and this person is often called an “influencer” or more generally, a social media account owner, since the followers are influenced by the content that the influencer posts to social media. It is often the case that such an influencer may have thousands of such followers tied to the influencer’s social media account. However, these followers may not be real legitimate people, but may instead be automated “bots” or fake accounts, perhaps a single person has set up many duplicate accounts, and each such duplicate account is listed as a follower of a particular influencer.

Accordingly, there is a need in the art for a way of determining whether these followers are actually legitimate individual unique people, as this information is highly useful, for example, in marketing, to determine whether an influencer really has the number of followers that the influencer claims to have.

### SUMMARY

The present disclosure provides a computer-implemented data processing method of validating legitimacy of a plurality of social media followers of a selected social media account owner, comprising steps, carried out by a social media follower scrubber tool, of: receiving an uploaded spreadsheet from a user, the spreadsheet including results of a web scraping operation, where a web scraping tool has been used to scrape data regarding the plurality of social media followers of the social media account owner selected by the user, where the spreadsheet has a plurality of rows, with each row representing one of the plurality of followers and a plurality of columns, with each column representing a characteristic feature related to the plurality of followers; presenting the user with a drag and drop graphical user interface functionality allowing the user to rearrange and rename the columns of the uploaded spreadsheet in accordance with a native spreadsheet format of the social media follower tool; mapping the uploaded spreadsheet to the native format spreadsheet in accordance with the results of the presenting step; applying a plurality of rules to the native format spreadsheet using a rules engine module, to determine which rows of the native format spreadsheet are to be deleted, by applying the plurality of rules to data in the rows of the native format spreadsheet, such data corresponding to specific columns of the native format spreadsheet which correspond to the plurality of rules; deleting the determined rows to generate an edited native format spreadsheet; and outputting the edited native format spreadsheet to the user.

The present disclosure also provides a data processing system corresponding to the method.

The present disclosure also provides a computer program stored on a computer readable storage medium, corresponding to the method.

### BRIEF DESCRIPTION OF DRAWINGS

FIG. 1 is a block diagram showing data processing functional blocks of a social media follower scrubber tool, arranged according to a preferred embodiment of the present disclosure;

FIG. 2 is a flow chart showing steps of a method of operating the social media follower scrubber tool, according to a preferred embodiment of the present disclosure; and

FIG. 3 is a table showing an example of two rules which could be implemented by the social media scrubber tool, according to a preferred embodiment.

### DETAILED DESCRIPTION OF THE PREFFERED EMBODIMENTS

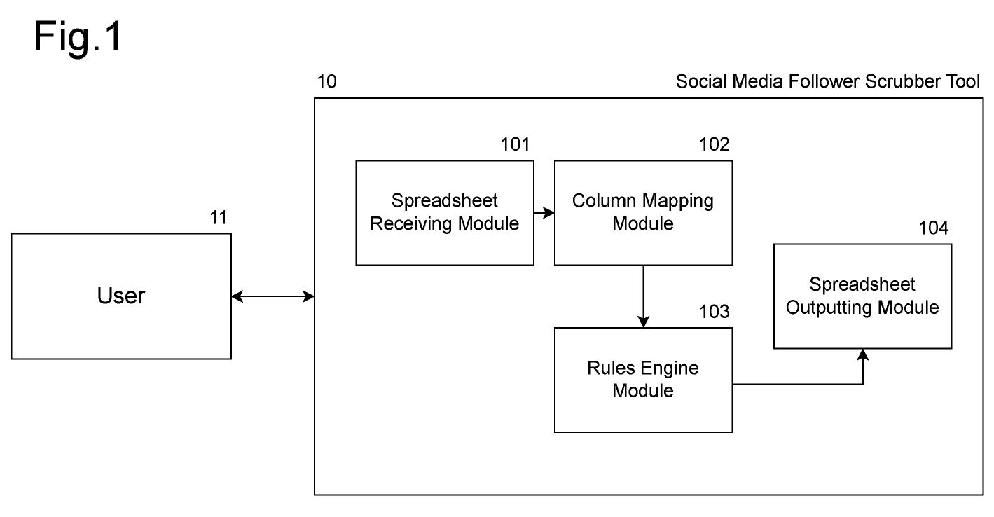

As shown in FIG. 1, the present disclosure provides, according to a preferred embodiment, a social media follower scrubber tool 10 which is implemented on, for example, a cloud based web server. The tool 10 interacts with a user 11 over a standard computer network. For example, the user 11 could be using a desktop computer running a web browser, which interacts with the web server over standard web protocols.

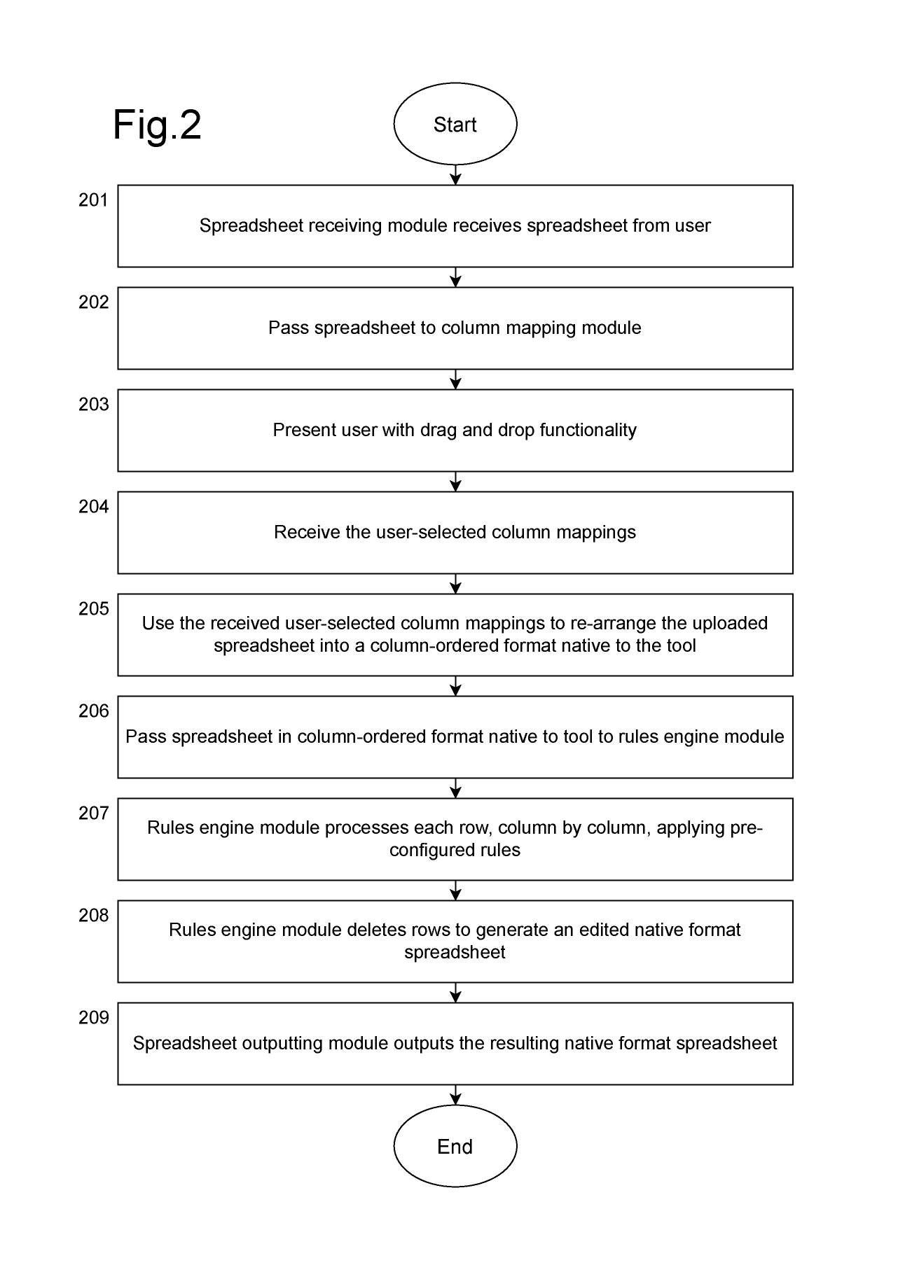

A description of the operation of the social media follower scrubber tool 10 will now be provided in conjunction with the flow chart of FIG. 2, taken together with the block diagram of FIG. 1.

At a first step 201, a user 11 uploads a spreadsheet to the social media follower scrubber tool 10, and specifically, a spreadsheet receiving module 101 of the tool 10 receives the spreadsheet which the user 11 has uploaded and sent to the tool 10 over the Internet, using standard web based communication protocols.

The spreadsheet has a plurality of rows, with each row representing a follower of a particular social media influencer. For example, prior to step 201, the user 11 has obtained the spreadsheet by, for example, navigating to a social media profile web page of an influencer, or, more generally, a social media account owner, which the user 11 selects, and using any of a plurality of known standard web scraper tools to scrape data from the social media profile web page of the user selected influencer. The data that is scraped is placed into a spreadsheet, by the known web scraper tools, with each row of the spreadsheet corresponding to one unique follower of the influencer. Typically, a popular influencer may have, for example, 100,000 followers, so the spreadsheet which results from the web scraping operation would have 100,000 rows.

The columns of the spreadsheet represent various parameters which the web scraping tool can define and collect from the data that is scraped. For example, one column could indicate, for a particular follower of the selected influencer, a number of social media posts that the follower has posted since the follower has joined the social media platform. Another column could contain the date of the last post that the follower has posted to the social media platform. Another column could be number of followers which the follower has on the follower’s social media profile web page. A further column could be a bio (short for “biography”) of the follower, containing some information about the follower, such as where the follower lives, what interests the follower has, etc. A further column could be an image url (uniform resource locator) which points to an image of a photograph of the follower. A still further column could contain a url of a personal website of the follower. A still further column could contain the name of the follower.

As is apparent from the above, the web scraping operation could result in many different columns, each providing specific information about the followers of an influencer. The particular columns which are used are configurable by the particular web scraping operation that is carried out and by the particular web scraping tool that is used.

The spreadsheet that is uploaded at step 201 could be in any of a plurality of known spreadsheet formats, such as csv, xlsx, gsheets or comma delimited text.

At step 202, the uploaded spreadsheet received by the tool 10’s spreadsheet receiving module 101 is then passed to the tool 10’s column mapping module 102. Column mapping module 102 presents (at step 203) the user 11, via a graphical user interface (GUI), with a drag and drop functionality that allows the user 11 to easily identify which columns the tool 10 is expecting to receive, and what those columns are named, and the user can then, using the drag and drop functionality, find the columns in the user’s uploaded spreadsheet that correspond to the columns that the tool 10 is expecting to receive and replace, column by column, the columns in the user’s uploaded spreadsheet with the columns which the tool is expecting to receive.

For example, if the column in the user’s uploaded spreadsheet, which has the biography or personal description of the follower is called “description”, and is located in one location in the uploaded spreadsheet (e.g., the third column) but the tool 10 is expecting to have a column called “bio” in the fifth column of the spreadsheet the tool 10 is expecting to receive, the user can use the drag and drop functionality of the GUI to interchange the third and fifth columns.

This mapping process, using the GUI, is then repeated for each of the columns which the tool 10 indicates to the user 11, via the GUI, as being mandatory columns that the tool 10 requires to perform its follower scrubber functions.

Accordingly, at step 204, the column mapping module 102 receives the user selected column mappings discussed above.

At step 205, the column mapping module 102 uses the received user selected column mappings and re-arranges the uploaded spreadsheet into the column ordered format which the tool 10 expects to receive (a native format of the tool 10), and also the names of the columns are changed to the names of the tool 10’s native format.

Accordingly, the column mapping module 102 allows for a wide variety of different formats of uploaded spreadsheets to be used, depending on the preferences of the user 11, and/or depending on the particular web data scraping tool that the user 11 has used to scrape the social media profile page of the selected influencer.

At step 206, the spreadsheet, which is now in the tool 10’s native format, is passed to the rules engine module 103 which processes the native format spreadsheet in a manner that will now be described to identify and remove/delete rows from the spreadsheet which correspond to followers of the selected influencer which followers are identified by the tool 10 as having a high probability of not being legitimate followers. For example, the identified rows could correspond to non-human “bots” or software programs, which may be created to impersonate a real person (real or fictitious) in order to increase the number of followers that a particular influencer has.

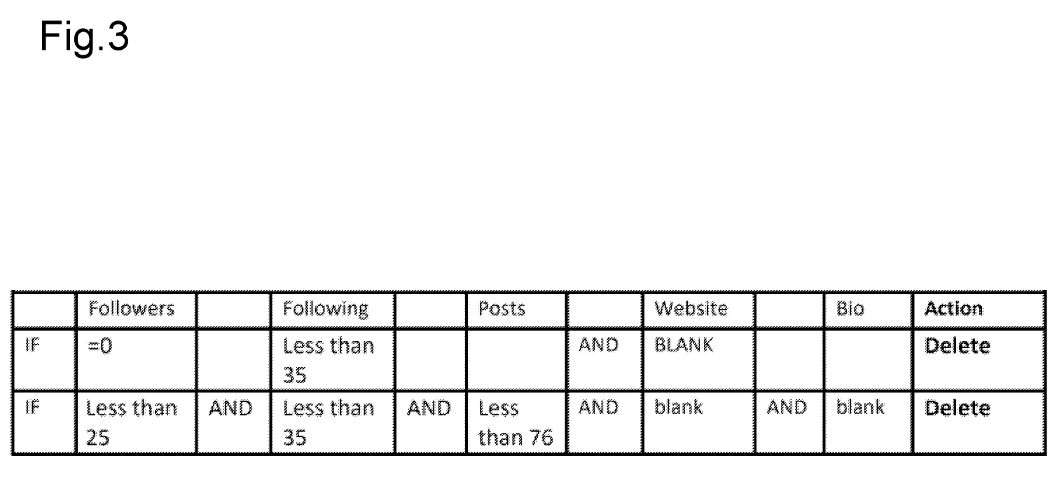

At step 207, the rules engine module 103 processes each row, column by column, by applying pre-configured rules to each row. This could be performed by a macro or by artificial intelligence logic, depending on the complexity of the spreadsheet being used. As an example, see FIG. 3 which is a table 30 illustrating two example rules which may be used by the rules engine module 103.

In FIG. 3, a first rule 31 in the first row of the table 30 includes the logic that if a particular row of the native format spreadsheet, representing a particular follower of the selected influencer, is named “Followers”, and if the value in the native format spreadsheet for that follower is 0 (zero), then this indicates that this particular follower of the selected influence has no followers of its own (no one is following this particular follower of the selected influencer). Another column of the native format spreadsheet is called “Following” and if the value in that column for the row of the particular follower, is less than 35, this indicates that the particular follower is following less than 35 influencers. Lastly, in rule 31, another column of the native format spreadsheet is called “Website” and if the value in that column for the row of the particular follower is blank (has no value in it), then this means that the particular follower does not have a personal website. Accordingly, for rule 31, if any particular row of the native format spreadsheet meets the conditions as specified in rule 31, then the action which is listed in rule 31 of table 30 in the Action column of table 30 is “Delete”. This means that this particular row of the native format spreadsheet should be deleted, thus indicating that this particular follower that corresponds to this row of the native format spreadsheet is determined by the tool 10 to be not a legitimate follower of the selected influencer.

As another example of a rule, rule 32 is shown, in the second row of FIG. 3. According to rule 32, if the particular follower corresponding to a particular row in the native format spreadsheet has less than 25 Followers of its own (as indicated in the Followers column of the native format spreadsheet), and the particular follower is following less than 35 influencers (as indicated in the Following column of the native format spreadsheet), and the particular follower has posted less than 76 posts on the social media site (as indicated in the Posts column of the native format spreadsheet) and the particular follower does not have a website (as indicated in the Website column of the native format spreadsheet) and the particular follower does not have a biography listed on the particular follower’s social media profile (as indicated in the Bio column of the native format spreadsheet), then, accordingly, for rule 32, if any particular row of the native format spreadsheet meets all the conditions as specified in rule 32, then the action which is listed in rule 32 of table 30 in the Action column of table 30 is “Delete”. This means that this particular row of the native format spreadsheet should be deleted, thus indicating that this particular follower that corresponds to this row of the native format spreadsheet is determined by the tool 10 to be not a legitimate follower of the selected influencer.

A wide variety of rules could be programmed to cover specific requirements. For example, a bio of a follower could contain gibberish text instead of actual text. If this is the case, the follower corresponding to the row of the native format spreadsheet is very likely to not be legitimate. As another example, if the word “crypto” or “blockchain” is included in a bio, this could indicate that the follower is not real, so word checks can be carried out by the rules engine module 103. As a further example, if an Image URL column is blank this means that the follower does not have a photograph showing the follower on the follower’s social media profile, and if this is the case, a rule could be specified to state a Delete action, as any legitimate follower would have a photo on its profile.

If two rows are determined to be identical, one can be deleted as being a duplicate. A common way to increase a number of claimed followers is to have the same person follow an influencer multiple times, and this rule could identify this.

If a row has a value in a column indicating that the follower does not have a social media profile at all, this row can be deleted, according to one possible rule. The logic here is that if an alleged follower doesn’t even have a profile on social media, the follower is probably not genuine.

A preferred ordering of the rules would be to first look at a plurality of numbers, such as the number of followers, number of influencers being followed, number of posts etc, and if those rules based on numbers cannot be passed, then the row can be deleted. Other rules could be compound rules where the number based rule has to be passed first, and if it is passed, then a further rule is considered, such as whether the bio column has gibberish text or real text, or contains the word “crypto” or “blockchain”, and if that rule is passed then a still further rule is checked as to whether the Image URL column indicates that the follower has a photograph in the follower’s social media profile.

The rules engine module 103 could go to outside sources to obtain information that the tool 10 can use to evaluate the rules. For example, the tool 10 could go to outside sources such as Google Images, to compare a follower’s photograph with others photographs of the follower on the Web, to validate that the profile picture is not being used as duplicate on social media, e.g., more than two profiles on Twitter for example with the same photograph, or to determine if there are multiple uses of the same photograph across different social media platforms.

A location column could indicate the follower’s geographic location, and this could be checked for validity by the rules engine module 013 using a geolocation API (Application Programming Interface).

A location of a profile photograph, from the metadata of the photograph, could be used and compared to the follower’s location in the location column.

At step 208, the rules engine 103 deletes the rows which are determined, as a result of application of the rules, should be deleted, to generate an edited native format spreadsheet.

At step 209, the spreadsheet outputting module 104 outputs the resulting edited native format spreadsheet, after the rules engine module 103 has determined which rows of the native format spreadsheet are corresponding to followers who are not determined to be legitimate and has deleted those and has thus edited the spreadsheet to create the resulting spreadsheet. The resulting spreadsheet output by the module 104 can contain a much smaller number of rows as compared to the uploaded spreadsheet. This resulting spreadsheet is then returned to the user over the Web by the module 104 of the tool 10.

Therefore, the resulting spreadsheet thus provides the user 11 with a much better indication of whether the followers which the user selected influencer claims to be following the influencer, are actually legitimate followers representing real people, as compared to fake people such as software “bots” or the like.

The resulting spreadsheet could be presented using the GUI to the user 11 along with a list of the followers whose rows have been eliminated by the tool, to thus allow the user 11 to look through the rows that have been eliminated by the tool in case the user 11 recognizes any of the followers as being actually legitimate even though the tool has determined that they are not legitimate.

Data sanitization techniques can be used to help ensure safe and properly formatted input data. For example, techniques can be employed for removing or replacing invalid characters using regular expressions, type checking, conversion and length checking, could be used. Utilizing prepared statements for SQL queries and validating/sanitizing user provided URLs can further enhance security.

1. A computer-implemented data processing method of validating legitimacy of a plurality of social media followers of a selected social media account owner, comprising steps, carried out by a social media follower scrubber tool, of:
receiving an uploaded spreadsheet from a user, the spreadsheet including results of a web scraping operation, where a web scraping tool has been used to scrape data regarding the plurality of social media followers of the social media account owner selected by the user, where the spreadsheet has a plurality of rows, with each row representing one of the plurality of followers and a plurality of columns, with each column representing a characteristic feature related to the plurality of followers;
presenting the user with a drag and drop graphical user interface functionality allowing the user to rearrange and rename the columns of the uploaded spreadsheet in accordance with a native spreadsheet format of the social media follower tool;
mapping the uploaded spreadsheet to the native format spreadsheet in accordance with the results of the presenting step;
applying a plurality of rules to the native format spreadsheet using a rules engine module, to determine which rows of the native format spreadsheet are to be deleted, by applying the plurality of rules to data in the rows of the native format spreadsheet, such data corresponding to specific columns of the native format spreadsheet which correspond to the plurality of rules;
deleting the determined rows to generate an edited native format spreadsheet; and
outputting the edited native format spreadsheet to the user.

2. The computer-implemented data processing method of claim 1, wherein the characteristic feature related to the plurality of followers is a number of social media posts that a corresponding follower has posted since joining a corresponding social media platform.

3. The computer-implemented data processing method of claim 1, wherein the characteristic feature related to the plurality of followers is a date of a last post which the corresponding follower has posted to a corresponding social media platform.

4. The computer-implemented data processing method of claim 1, wherein the characteristic feature related to the plurality of followers is a number of followers which the corresponding follower has on a corresponding follower’s social media page.

5. The computer-implemented data processing method of claim 1, wherein the characteristic feature related to the plurality of followers is a biography of a corresponding follower.

6. The computer-implemented data processing method of claim 1, wherein the characteristic feature related to the plurality of followers is an image uniform resource locator which points to an image of a photograph of a corresponding follower.

7. The computer-implemented data processing method of claim 1, wherein the characteristic feature related to the plurality of followers is a name of a corresponding follower.

8. The computer-implemented data processing method of claim 1, wherein the applying step uses artificial intelligence logic to apply the plurality of rules to data in the rows of the native format spreadsheet.

9. The computer-implemented data processing method of claim 1, wherein the applying step determines that a row is to be deleted if two rows are determined to be identical.

10. The computer-implemented data processing method of claim 1, wherein the applying step determines that a row is to be deleted if a corresponding follower is determined to not have a social media profile.

11. The computer-implemented data processing method of claim 1, wherein the applying step firstly takes into account a plurality of numbers and determines that a row is to be deleted if the data in the row does not satisfy the plurality of rules regarding the plurality of numbers.

12. The computer-implemented data processing method of claim 11, wherein the plurality of numbers includes a number of followers, a number of influencers, and a number of posts.

13. The computer-implemented data processing method of claim 11, wherein the applying step secondly takes into account text-based data to determine whether a row is to be deleted.

14. The computer-implemented data processing method of claim 13, wherein the applying step thirdly takes into account an image uniform resource locator data to determine whether a row is to be deleted.

15. The computer-implemented data processing method of claim 1, wherein the applying step compares a corresponding follower's photographic data with other photographic data obtained via an Internet search, to determine whether a row should be deleted.

16. The computer-implemented data processing method of claim 1, wherein the applying step checks a corresponding follower's geographic location which is included in a column of the spreadsheet, for validity using a geolocation Application Programming Interface, API, to determine whether a row should be deleted.

17. The computer-implemented data processing method of claim 1, wherein the applying step checks a location of a corresponding follower's social media profile photograph from metadata included in the photograph, in determining whether a row should be deleted.

18. A data processing system having a processor and a memory for storing instructions, wherein the processor causes the system to execute a computer-implemented data processing method of validating legitimacy of a plurality of social media followers of a selected social media account owner, comprising steps, carried out by a social media follower scrubber tool, of:
receiving an uploaded spreadsheet from a user, the spreadsheet including results of a web scraping operation, where a web scraping tool has been used to scrape data regarding the plurality of social media followers of the social media account owner selected by the user, where the spreadsheet has a plurality of rows, with each row representing one of the plurality of followers and a plurality of columns, with each column representing a characteristic feature related to the plurality of followers;
presenting the user with a drag and drop graphical user interface functionality allowing the user to rearrange and rename the columns of the uploaded spreadsheet in accordance with a native spreadsheet format of the social media follower tool;
mapping the uploaded spreadsheet to the native format spreadsheet in accordance with the results of the presenting step;
applying a plurality of rules to the native format spreadsheet using a rules engine module, to determine which rows of the native format spreadsheet are to be deleted, by applying the plurality of rules to data in the rows of the native format spreadsheet, such data corresponding to specific columns of the native format spreadsheet which correspond to the plurality of rules;
deleting the determined rows to generate an edited native format spreadsheet; and
outputting the edited native format spreadsheet to the user.

19. A computer program stored on a computer readable storage medium for, when executed on a computer system having a processor, instructing the processor to carry out a computer-implemented data processing method of validating legitimacy of a plurality of social media followers of a selected social media account owner, comprising steps, carried out by a social media follower scrubber tool, of:
receiving an uploaded spreadsheet from a user, the spreadsheet including results of a web scraping operation, where a web scraping tool has been used to scrape data regarding the plurality of social media followers of the social media account owner selected by the user, where the spreadsheet has a plurality of rows, with each row representing one of the plurality of followers and a plurality of columns, with each column representing a characteristic feature related to the plurality of followers;
presenting the user with a drag and drop graphical user interface functionality allowing the user to rearrange and rename the columns of the uploaded spreadsheet in accordance with a native spreadsheet format of the social media follower tool;
mapping the uploaded spreadsheet to the native format spreadsheet in accordance with the results of the presenting step;
applying a plurality of rules to the native format spreadsheet using a rules engine module, to determine which rows of the native format spreadsheet are to be deleted, by applying the plurality of rules to data in the rows of the native format spreadsheet, such data corresponding to specific columns of the native format spreadsheet which correspond to the plurality of rules;
deleting the determined rows to generate an edited native format spreadsheet; and
outputting the edited native format spreadsheet to the user.
